(19) United States
(12) Patent Application Publication
(10) Pub. No.: US 2014/0189201 A1
(43) Pub. Date: Jul. 3, 2014

(54) Flash Memory Interface Using Split Bus Configuration

(71) Applicants: Krishnamurthy Dhakshinamurthy, Bangalore (IN); Rajeev Nagabhirava, Santa Clara, CA (US); Tony Ahwal, Santa Cruz, CA (US); Leeladhar Agarwal, Bangalore (IN); Piyush Anil Dhotre, Bangalore (IN)

(72) Inventors: Krishnamurthy Dhakshinamurthy, Bangalore (IN); Rajeev Nagabhirava, Santa Clara, CA (US); Tony Ahwal, Santa Cruz, CA (US); Leeladhar Agarwal, Bangalore (IN); Piyush Anil Dhotre, Bangalore (IN)

(21) Appl. No.: 13/793,609

(22) Filed: Mar. 11, 2013

(30) Foreign Application Priority Data
Dec. 31, 2012 (IN) 5508/CHE/2012

(51) Int. Cl. G06F 12/02

(52) U.S. Cl. CPC G06F 12/0246
USPC 711/103

(57) ABSTRACT

A system having a split bus flash memory and a method for operating the split bus flash memory is disclosed. The system may include a controller, a non-volatile memory (including first and second non-volatile memory chips) and the system bus. The controller is configured to communicate via an N-bit bus. The first and second non-volatile memory chips are configured to communicate via an M-bit bus, with M<N. The system bus connects the controller with the first and second non-volatile memory chips, wherein the system bus is split with some of the system bus lines connected to the first non-volatile memory chip and other of the system bus lines connected to the second non-volatile memory chip. In this way, the controller may communicate command, address and/or data with the memory chips in parallel.

### REFERENCE TO RELATED APPLICATION

This application claims priority under 35 U.S.C. §119 to Indian Patent Application No. 5508/CHE/2012, filed on Dec. 31, 2012, the disclosure of which is incorporated by reference herein in its entirety.

### TECHNICAL FIELD

This application relates generally to managing data in a memory system. More specifically, this application relates to the operation of a flash memory interface using a split bus configuration.

### BACKGROUND

When writing data to a conventional flash data memory system, a host typically assigns unique logical addresses to sectors, clusters or other units of data within a continuous virtual address space of the memory system. The host writes data to, and reads data from, addresses within the logical address space of the memory system. The system controller of the memory system then commonly maps data between the logical address space and the physical blocks of the memory, and then accesses one or more flash memory chips using the physical blocks.

There are instances where the system controller supports a different bus interface than the flash memory chips, such as when the flash memory chips are of a legacy design. For example, the system controller may support a 16 bit bus interface whereas the flash memory chips support an 8 bit bus interface. Integrating the legacy flash memory chips with the system controller results in a reduction in performance of the memory system due to the mismatch in the different bus interfaces.

### BRIEF SUMMARY

A controller for a non-volatile memory system and a method for operating the controller are provided. In one aspect, the controller comprises a flash memory interface that includes an N-bit bus interface configured to communicate via an N-bit bus, with the controller configured to: communicate concurrently with a first non-volatile memory chip via a first M bits of the N-bit bus and with a second non-volatile memory chip via a second M bits of the N-bit bus, the first and second non-volatile memory chips configured to communicate via an M-bit bus, with M<N, the first M bits of the N-bit bus being mutually exclusive to the second M bits of the N-bit bus. For example, the N-bit bus may comprise a 16 bit bus, the first M bits of the N-bit bus may comprise a lower 8 bits of the 16 bit bus, and the second M bits of the N-bit bus may comprise an upper 8 bits of the 16 bit bus.

The controller is configured to concurrently (such as, for example, partly or completely simultaneously) communicate with the first and second non-volatile memory chips by duplicating one or both of address data and command data onto the first M bits of the N-bit bus and the second M bits of the N-bit bus. Further, the flash memory interface may further include a first chip enable and a second chip enable, with the controller further configured to: concurrently output an indication of activating the first non-volatile memory chip via the first chip enable and an indication of activating the second non-volatile memory chip via the second chip enable; and concurrently communicate data to or receive data from the first non-volatile memory chip via the first M bits of the N-bit bus and with the second non-volatile memory chip via the second M bits of the N-bit bus.

The controller may be further configured to: receive an indication of an error in a section (e.g., a block) of the first non-volatile memory chip or the second non-volatile memory chip; update a list of faulty sections with the indication of the error; and interpret the list of faulty sections as faulty sections on both the first non-volatile memory chip and the second non-volatile memory chip.

In another aspect, a method for a controller of a non-volatile memory system to communicate with a first non-volatile memory chip and a second non-volatile memory chip using a flash memory interface is provided. The flash memory interface of the controller may comprise an N-bit bus interface configured to communicate via an N-bit bus. The method includes: sending a first communication via the flash memory interface to the first non-volatile memory chip via a first M bits of the N-bit bus; and concurrently with the sending of the first communication, sending a second communication via the flash memory interface to the second non-volatile memory chip via a second M bits of the N-bit bus, wherein M<N, and wherein the first M bits of the N-bit bus are mutually exclusive to the second M bits of the N-bit bus.

A non-volatile memory system and a method for operating the non-volatile memory system are provided. In one aspect, the non-volatile memory system comprises: a controller, a non-volatile memory and a system bus. The controller includes a non-volatile memory interface configured to communicate via an N-bit bus. The non-volatile memory includes first and second non-volatile memory chips, the first and second non-volatile memory chips configured to communicate via an M-bit bus, with M<N. The system bus includes a plurality of communication lines connecting the non-volatile memory interface with the first and second non-volatile memory chips, wherein at least one of the plurality of communication lines connected between one of the N communication lines of the non-volatile memory interface and the first non-volatile memory chip is not connected to the second non-volatile memory chip.

The plurality of communication lines of the system bus may include a first set of communication lines and a second set of communication lines, wherein the first set of communication lines are connected between M of the N communication lines of the non-volatile memory interface and the first non-volatile memory chip, and wherein the second set of communication lines are connected between a different M of the N communication lines of the non-volatile memory interface and the second non-volatile memory chip. Further, the controller of the non-volatile memory system may be configured to send a command and/or an address on the system bus, the command and/or address being duplicated concurrently on the first set of communication lines and the second set of communication lines. In addition, the controller of the non-volatile memory system may further be configured to: receive from one of the first memory chip or the second memory chip an indication of a defective section; and record the defective section in a list of defective sections, the list indicative of defective sections on both the one of the first memory chip or the second memory chip.

Other features and advantages will become apparent upon review of the following drawings, detailed description and claims. Additionally, other embodiments are disclosed, and each of the embodiments can be used alone or together in combination. The embodiments will now be described with reference to the attached drawings.

### BRIEF DESCRIPTION OF THE DRAWINGS

The system may be better understood with reference to the following drawings and description. In the figures, like reference numerals designate corresponding parts throughout the different views.

FIG. 1 illustrates a host connected with a memory system having a multi-bank non-volatile memory containing multiple die.

FIG. 2A is an example block diagram of an example flash memory system controller for use in the multiple die non-volatile memory of FIG. 1.

FIG. 2B is an example of multiple flash memory interfaces using a split bus configuration.

FIG. 3 is an example one flash memory bank suitable as one of the non-volatile memory banks illustrated in FIG. 1.

FIG. 4 is a representative circuit diagram of a memory cell array that may be used in the memory bank of FIG. 3.

FIG. 5 illustrates an example physical memory organization of the memory bank of FIG. 3.

FIG. 6 shows an expanded view of a portion of the physical memory of FIG. 5.

FIG. 7 is a flow diagram of a method of communicating with multiple die in parallel using the split bus.

FIG. 8 is a flow diagram of a method of writing data to multiple die in parallel using the split bus.

FIG. 9 is a flow diagram of a method of recording bad sections in the multiple die when communicating via a split bus.

### DETAILED DESCRIPTION

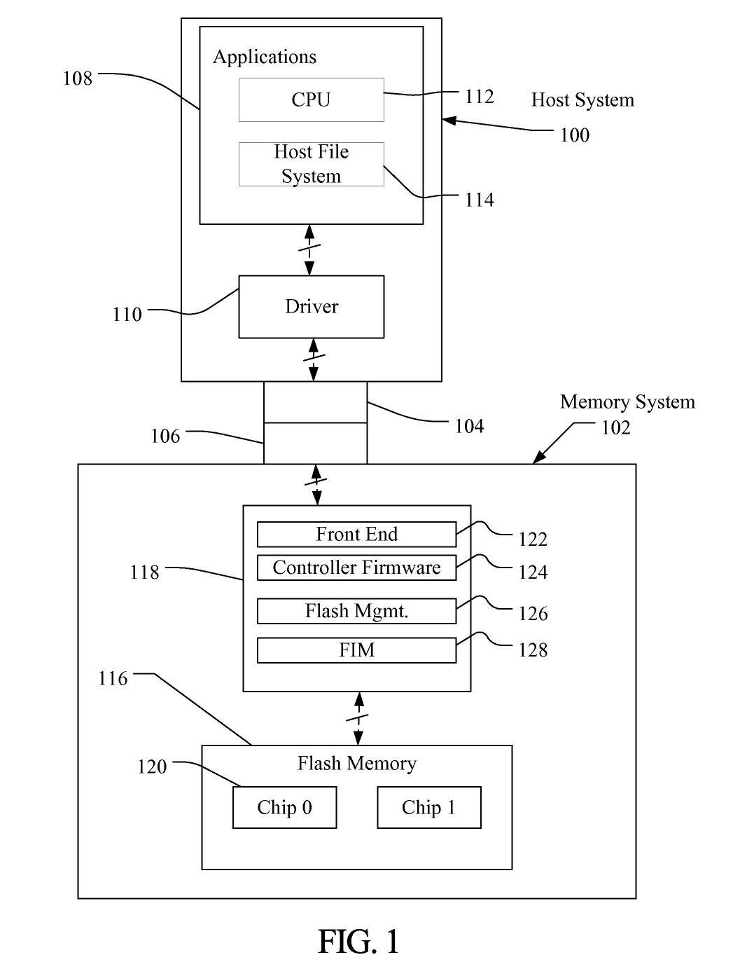

A flash memory system suitable for use in implementing aspects of the invention is shown in FIGS. 1-6. A host system 100 of FIG. 1 stores data into and retrieves data from a memory system 102. The memory system 102 may be flash memory embedded within the host, such as in the form of a solid state disk (SSD) drive installed in a personal computer. Alternatively, the memory system 102 may be in the form of a card that is removably connected to the host system 100 through mating parts 104 and 106 of a mechanical and electrical connector as illustrated in FIG. 1. A flash memory configured for use as an internal or embedded SSD drive may look similar to the schematic of FIG. 1, with the primary difference being the location of the memory system 102 internal to the host system 100. SSD drives may be in the form of discrete modules that are drop-in replacements for rotating magnetic disk drives.

The host system 100 of FIG. 1 may be viewed as having two major parts, insofar as the memory system 102 is concerned, made up of a combination of circuitry and software. They are an applications portion 108 and a driver portion 110 that interfaces with the memory system 102. In a PC, for example, the applications portion 110 can include a processor 112 running word processing, graphics, control or other popular application software, as well as the file system 114 for managing data on the host system 100. In a camera, cellular telephone or other host system that is primarily dedicated to performing a single set of functions, the applications portion 108 includes the software that operates the camera to take and store pictures, the cellular telephone to make and receive calls, and the like.

The memory system 102 of FIG. 1 may include non-volatile memory, such as flash memory 116, and a system controller 118 that both interfaces with the host system 100 to which the memory system 102 is connected for passing data back and forth and controls the flash memory 116. The system controller 118 may convert between logical addresses of data used by the host system 100 and physical addresses of the flash memory 116 during data programming and reading. The flash memory 116 may include any number of memory die or memory chips 120 and two memory die are shown in FIG. 1 simply by way of illustration. As discussed in more detail below, two, four, or more memory die may be used. The system controller 118 may perform a variety of functions. FIG. 1 illustrates the various functions of the system controller 118, including a front end 122 that interfaces with the host system 100, controller logic 124 for coordinating operation of the flash memory 116, flash management logic 126 for internal memory management operations such as garbage collection, and one or more flash interface modules (FIMs) 128 to provide a communication interface between the system controller 118 with the flash memory 116. The functions of the system controller 118 as depicted in FIG. 1 are merely for illustration purposes.

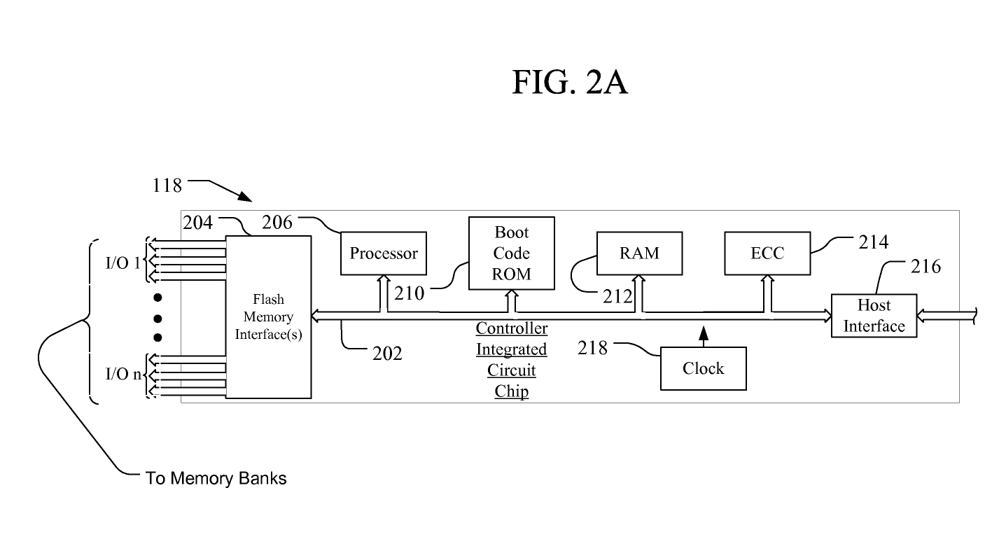

The system controller 118 may be implemented on a single integrated circuit chip, such as an application specific integrated circuit (ASIC), as shown in FIG. 2A. Further, the various functions performed by the system controller 118 may be performed by a single device, or may be performed by multiple devices, such as shown in FIG. 2A. More specifically, the system controller 118 may be segmented into the different devices illustrated in FIG. 2A, such as flash memory interface(s) 204, processor 206, RAM 212, ECC 214, host interface 216, and clock 218. FIG. 2A is merely for illustration purposes.

The processor 206 of the system controller 118 may be configured as a multi-thread processor capable of communicating separately with each of the respective memory chip 120 via one or more flash memory interface(s) 204, which is one way to perform the function of the FIM.

The flash memory interface(s) 204 may have I/O ports for each of the respective chip 120 in the flash memory 116. The system controller 118 may include an internal clock 218. The processor 206 may communicate with an error correction code (ECC) module 214, a RAM buffer 212, a host interface 216, and boot code ROM 210 via an internal data bus 202.

FIG. 2B illustrates one example of a schematic layout of the flash memory interface(s) 204 and the flash memory chips 232, 234, 236, 238. As discussed above, the system controller 118 may include multiple functions, such as interfacing with the memory die. One way in which the system controller 118 may interface with the flash memory chips is via flash memory interface(s) 204. Further, as discussed in the background, the system controller 118 may support a different bus interface than the flash memory chips. For example, as illustrated in FIG. 2B, the system controller 118 may support a 16 bit bus interface whereas the flash memory chips support an 8 bit bus interface. As discussed in more detail below, the split bus design as illustrated in FIG. 2B and programming of the system controller 118 enables an increase in performance in spite of the mismatch in the different bus interfaces.

Flash memory interface(s) 204 are illustrated as FIM0 and FIM1. FIM0 and FIM1 support a 16 bit data bus interface (as illustrated by data bus (15:0)). Other data buses of the flash memory interface, such as s 32 bit data bus, are contemplated. One example of a memory chip 120 are NAND memory chips 232, 234, 236, 238. Other types of memory chips 120 are contemplated. The flash memory chips 232, 234, 236, 238, as illustrated in FIG. 2B, support an 8 bit data bus interface. Thus, the number of data lines supported by the flash memory chips 232, 234, 236, 238 are less than the number of data lines that are supported by the flash memory interface. For example, the flash memory chips 232, 234, 236, 238 support an 8 bit data bus whereas the flash memory interface 204 support a 16 bit data bus.

In one embodiment, the bus of the flash memory interface is split between multiple flash memory chips. For example, the flash memory interface may support an N-bit bus (such as a 16 bit bus) and the flash memory chips may support an M-bit bus (such as an 8 bit bus), with M<N. As shown in FIG. 2B, multiple flash memory chips are paired to a flash memory interface (such as flash memory chips 232 and 234 paired to FIM0). The lines (or conductive traces) for the N-bit bus may be split or segmented so that one or more of the lines in the N-bit bus is connected to one of the flash memory chips but is not connected to another of the flash memory chips paired to the same flash memory interface. For example, lines (7:0) are connected to flash memory chip 232 and lines (15:8) are connected to flash memory chip 234. In this example, the N-bit bus may be split such that equal numbers of bus lines are connected to the flash memory chips. In particular, the bus of the flash memory device interface is split so that ½ of the bus lines are sent to one flash memory chip in the pair of memory chips (such as the bus lines (7:0) to flash memory chip 232 or 236) and the other ½ of the bus lines are sent to the other flash memory chip in the memory chip pair (such as bus lines (15:8) to flash memory chip 234 or 238).

FIG. 2B, which shows a pair of flash memory chips in communication with a single flash memory interface, is merely for purposes of illustration. Different numbers of flash memory chips (such as four flash memory chips in communication with the single flash memory interface) are contemplated. In the instance where four flash memory chips are in communication with the single flash memory interface supporting 16 bus lines, ¼ of the bus lines may be sent to each of the four flash memory chips (such as lines (3:0) to a first flash memory chip, lines (7:4) to the second flash memory chip, lines (11:8) to the third flash memory chip, and lines (15:12) to the fourth flash memory chip). Again, the different examples of the division of the bus lines are merely for illustration purposes. Rather, the bus lines from a specific flash memory interface are segmented to the different flash memory chips so that one or more bus lines are connected to one flash memory chip but are not connected to another flash memory chip in the group of flash memory chips that communicate with the specific flash memory interface.

In addition, the flash memory interface of the system controller 118 may be configured such that one or more operations of the flash memory interface may be performed in parallel. As discussed above, the split bus is configured to split or segment the bus that electrically connects the flash memory interface of the system controller 118 with multiple flash memory chips. In synergy with the split bus, the flash memory interface may be programmed such that certain operations to interface with the multiple flash memory chips (which are connected with the flash memory interface) may be performed in parallel. Examples of operations include, but are not limited to: sending a command to the flash memory chips (such as a read, write or erase command); sending an address to the flash memory chips; and sending data to or from the flash memory chips (such as sending data to the flash memory chips to write to memory or sending data from the flash memory chips to read from memory). The examples of operations are merely for illustration purposes.

Referring back to FIG. 2B, FIM0 uses different pins including: Flash Data (FD) Bus; ALE (address latch enable); CLE (command latch enable); WP (write protect, if asserted, indicates no write to the memory); WE (write enable); CE0 (chip enable 0 for enabling chip 0); CE1 (chip enable 1 for enabling chip 1); RDY/BSY (Ready/Busy).

As discussed in more detail below, using the split bus, commands and/or addresses may be latched onto the data bus lines in parallel. For example, when the CLE pin is driven high, the FIM may output a command onto different parts of the split bus, thereby utilizing each of the 16 lines and communicating with multiple flash memory chips. In particular, the command may only use 8 bits. So that, in the configuration illustrated in FIG. 2B, the same command may be output concurrently (e.g., simultaneously) onto the different parts of the split bus, such onto as lines (7:0) for Chip 0 (120A) and onto lines (15:8) for Chip 1 (120B). For example, the command is on lines (7:0) and lines (15:8) at least partly at the same time such that there is an overlap when the data is on lines (7:0) and on lines (15:8). More specifically, the system controller may begin to drive and/or end the drive of the command onto lines (7:0) and lines (15:8) at the same time. Thus, the system controller 118 (such as FIM0 or FIM1) may be configured to duplicate the command on the different parts of the split bus. In this way, the command may be sent to Chip 0 and Chip 1 in parallel.

Likewise, when ALE is driven high, the FIM may output an address onto different parts of the split bus, thereby utilizing each of the 16 lines and communicating with multiple flash memory chips. In particular, the address may only use 8 bits. So that, in the configuration illustrated in FIG. 2B, the same address may be output concurrently (e.g., simultaneously) onto the different parts of the split bus, such onto lines (7:0) for Chip 0 (120A) and onto lines (15:8) for Chip 1 (120B). More specifically, the system controller 118 (such as FIM0 or FIM1) may be configured to duplicate the address on the different parts of the split bus. As discussed in more detail below, since the same address is sent to each of the multiple flash memory chips, the system controller 118 may use the same address to access memory locations with the same associated address in the each of the multiple flash memory chips. By way of example, if either read or write access to memory locations with 8-bit address “01101111” is sought, the system controller 118 may send the 8-bit address concurrently to each of the flash memory chips (such as flash memory chips 232 and 234). For example, the 8-bit address “01101111” is on lines (7:0) and lines (15:8) at least partly at the same time such that there is an overlap when the data is on lines (7:0) and on lines (15:8). More specifically, the system controller may begin to drive and/or end the drive of 8-bit address “01101111” onto lines (7:0) and lines (15:8) at the same time. Responsive to receipt of the address, each of the flash memory chips (such as flash memory chips 232 and 234) may access the memory locations at the designated address, thereby operating in parallel. In this way, the address may be sent to Chip 0 and Chip 1 in parallel.

Further, the FIM may send to or receive data from the different parts of the split bus in parallel. So that, when data is being written to the flash memory chips, the FIM drives data onto the entire data bus (such as each of the 16 lines in the bus illustrated in FIG. 2B) in order for each of the memory chips paired with the FIM (such as chip 0 (120A) and chip 1 (120B)) to receive data concurrently (e.g., simultaneously). For example, the data is on lines (7:0) and lines (15:8) at least partly at the same time such that there is an overlap when the data is on lines (7:0) and on lines (15:8). More specifically, the system controller may begin to drive and/or end the drive data onto lines (7:0) and lines (15:8) at the same time. In this way, data may be transmitted using the entire 16 bit bus when writing data to the different flash memory chips. Likewise, when data is being read from the flash memory chips, the FIM reads data from the entire data bus (such as each of the 16 lines in the bus illustrated in FIG. 2B) in order for each of the memory chips paired with the FIM (such as chip 0 (120A) and chip 1 (120B)) to transmit data simultaneously. Again, in this way, the entire 16 bit bus may be utilized when reading data from the different flash memory chips. Unlike the command or address output onto the split bus, the data on the split bus is not identical. In the configuration illustrated in FIG. 2B, the bus is designated for transmission of data when both CLE and ALE are driven low.

The FIM further may receive an input, via the RDY/BSY pin, to determine whether the flash memory chip(s) are ready or busy. Because multiple flash memory chips are communicating with the FIM, the signals from the different flash memory chips may be combined to indicate to the FIM when both of the flash memory chips are ready or busy. FIG. 2B illustrates that the signals from the flash memory chips are input to a logical AND gate 240, with the output of the AND gate 240 being connected to RDY/BSY pin. The AND gate 240 is merely one representation of the way in which to combine the signals from the different flash memory chips. Drain outputs from the different memory chips may be tied together to form an equivalent to a logical AND gate.

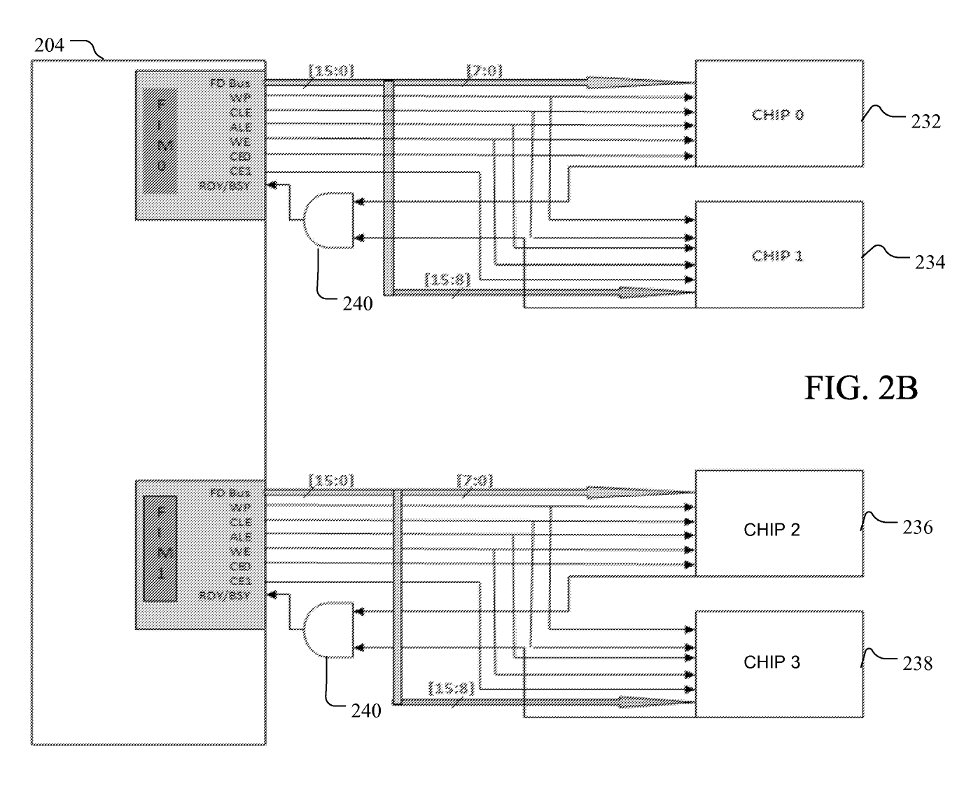

Each chip 120 in the flash memory 116 may contain an array of memory cells organized into multiple planes. FIG. 3 shows planes 310 and 312 for simplicity but a greater number of planes, such as four or eight planes, may instead be used. Alternatively, the memory cell array of a memory bank may not be divided into planes. When so divided, however, each plane has its own column control circuits 314 and 316 that are operable independently of each other. The circuits 314 and 316 receive addresses of their respective memory cell array, and decode them to address a specific one or more of respective bit lines 318 and 320. The word lines 322 are addressed through row control circuits 324 in response to addresses received on the bus 308. Source voltage control circuits 326 and 328 are also connected with the respective planes, as are p-well voltage control circuits 330 and 332. If the bank 300 is in the form of a memory chip with a single array of memory cells, and if two or more such chips exist in the system, data are transferred into and out of the planes 310 and 312 through respective data input/output circuits 334 and 336 that are connected with the bus 308. The circuits 334 and 336 provide for both programming data into the memory cells and for reading data from the memory cells of their respective planes, through lines 338 and 340 connected to the planes through respective column control circuits 314 and 316.

Although the processor 206 in the system controller 118 controls the operation of the memory chips in each chip 120 to program data, read data, erase and attend to various housekeeping matters, each memory chip also contains some controlling circuitry that executes commands from the controller 118 to perform such functions. Interface circuits 342 are connected to the bus 308. Commands from the controller 118 are provided to a state machine 344 that then provides specific control of other circuits in order to execute these commands. Control lines 346-354 connect the state machine 344 with these other circuits as shown in FIG. 3. Status information from the state machine 344 is communicated over lines 356 to the interface 342 for transmission to the controller 118 over the bus 308.

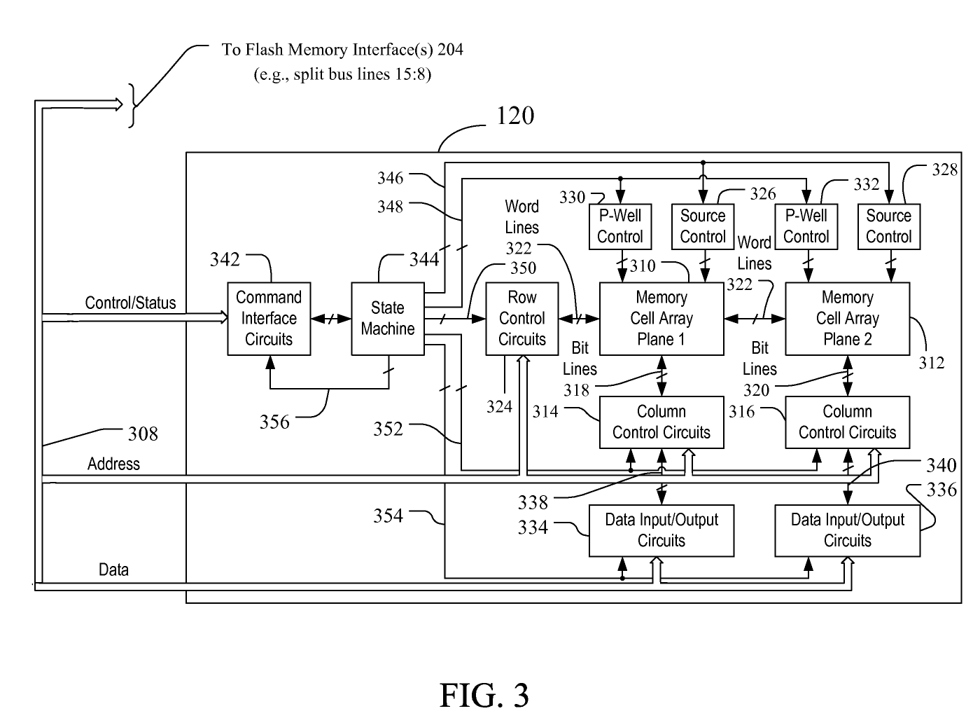

A NAND architecture of the memory cell arrays 310 and 312 is discussed below, although other architectures, such as NOR, can be used instead. An example NAND array is illustrated by the circuit diagram of FIG. 4, which is a portion of the memory cell array 310 of the memory bank 300 of FIG. 3. A large number of global bit lines are provided, only four such lines 402-408 being shown in FIG. 4 for simplicity of explanation. A number of series connected memory cell strings 410-424 are connected between one of these bit lines and a reference potential. Using the memory cell string 414 as representative, a plurality of charge storage memory cells 426-432 are connected in series with select transistors 434 and 436 at either end of the string. When the select transistors of a string are rendered conductive, the string is connected between its bit line and the reference potential. One memory cell within that string is then programmed or read at a time.

Word lines 438-444 of FIG. 4 individually extend across the charge storage element of one memory cell in each of a number of strings of memory cells, and gates 446 and 450 control the states of the select transistors at each end of the strings. The memory cell strings that share common word and control gate lines 438-450 are made to form a block 452 of memory cells that are erased together. This block of cells contains the minimum number of cells that are physically erasable at one time. One row of memory cells, those along one of the word lines 438-444, are programmed at a time. Typically, the rows of a NAND array are programmed in a prescribed order, in this case beginning with the row along the word line 444 closest to the end of the strings connected to ground or another common potential. The row of memory cells along the word line 442 is programmed next, and so on, throughout the block 452. The row along the word line 438 is programmed last.

A second block 454 is similar, its strings of memory cells being connected to the same global bit lines as the strings in the first block 452 but having a different set of word and control gate lines. The word and control gate lines are driven to their proper operating voltages by the row control circuits 324. If there is more than one plane in the system, such as planes 1 and 2 of FIG. 3, one memory architecture uses common word lines extending between them. There can alternatively be more than two planes that share common word lines. In other memory architectures, the word lines of individual planes are separately driven.

The memory cells may be operated to store two levels of charge so that a single bit of data is stored in each cell. This is typically referred to as a binary or single level cell (SLC) memory. Alternatively, the memory cells may be operated to store more than two detectable levels of charge in each charge storage element or region, thereby to store more than one bit of data in each. This latter configuration is referred to as multi level cell (MLC) memory. Both types of memory cells may be used in a memory, for example binary flash memory may be used for caching data and MLC memory may be used for longer term storage. The charge storage elements of the memory cells are most commonly conductive floating gates but may alternatively be non-conductive dielectric charge trapping material.

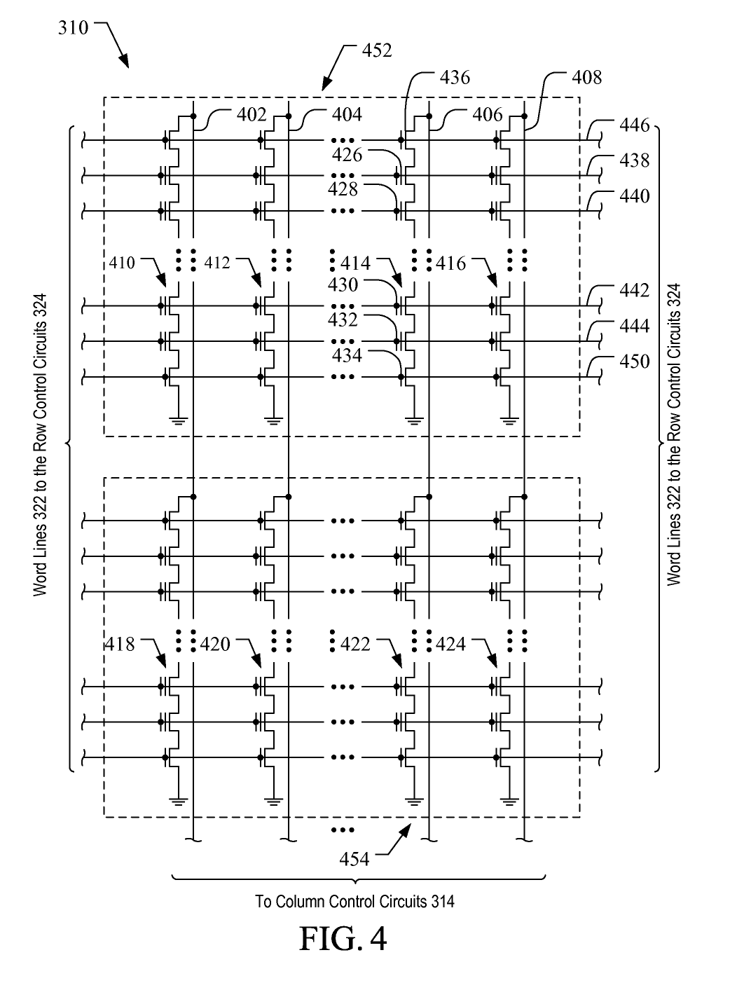

FIG. 5 conceptually illustrates a multiple plane arrangement showing four planes 502-508 of memory cells. These planes 502-508 may be on a single die, on two die (two of the planes on each die) or on four separate die. Of course, other numbers of planes, such as 1, 2, 8, 16 or more may exist in each die of a system. The planes are individually divided into blocks of memory cells shown in FIG. 5 by rectangles, such as blocks 510, 512, 514 and 516, located in respective planes 502-508. There can be dozens or hundreds of blocks in each plane.

As mentioned above, a block of memory cells is the unit of erase, the smallest number of memory cells that are physically erasable together. For increased parallelism, however, the blocks are operated in larger metablock units. One block from each plane is logically linked together to form a metablock. The four blocks 510-516 are shown to form one metablock 518. All of the cells within a metablock are typically erased together. The blocks used to form a metablock need not be restricted to the same relative locations within their respective planes, as is shown in a second metablock 520 made up of blocks 522-528. Although it is usually preferable to extend the metablocks across all of the planes, for high system performance, the memory system can be operated with the ability to dynamically form metablocks of any or all of one, two or three blocks in different planes. This allows the size of the metablock to be more closely matched with the amount of data available for storage in one programming operation.

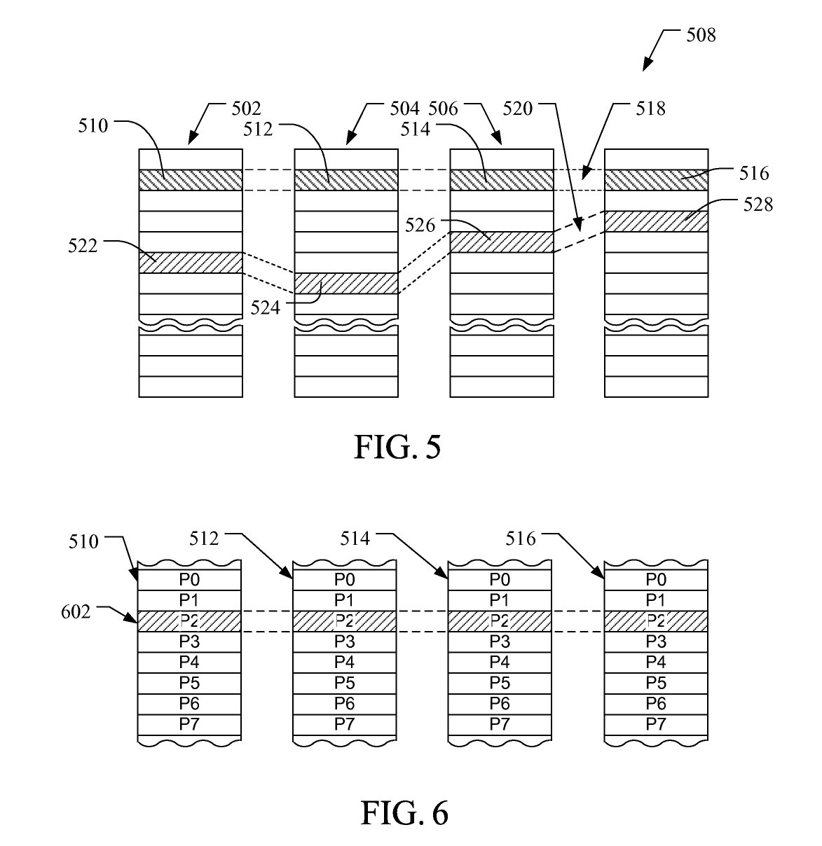

The individual blocks are in turn divided for operational purposes into pages of memory cells, as illustrated in FIG. 6. The memory cells of each of the blocks 510-516, for example, are each divided into eight pages P0-P7. Alternatively, there may be 32, 64 or more pages of memory cells within each block. The page is the unit of data programming and reading within a block, containing the minimum amount of data that are programmed or read at one time. In the NAND architecture of FIG. 3, a page is formed of memory cells along a word line within a block. However, in order to increase the memory system operational parallelism, such pages within two or more blocks may be logically linked into metapages. A metapage 602 is illustrated in FIG. 6, being formed of one physical page from each of the four blocks 510-516. The metapage 602, for example, includes the page P2 in each of the four blocks but the pages of a metapage need not necessarily have the same relative position within each of the blocks. Within a die, a metapage is the maximum unit of programming.

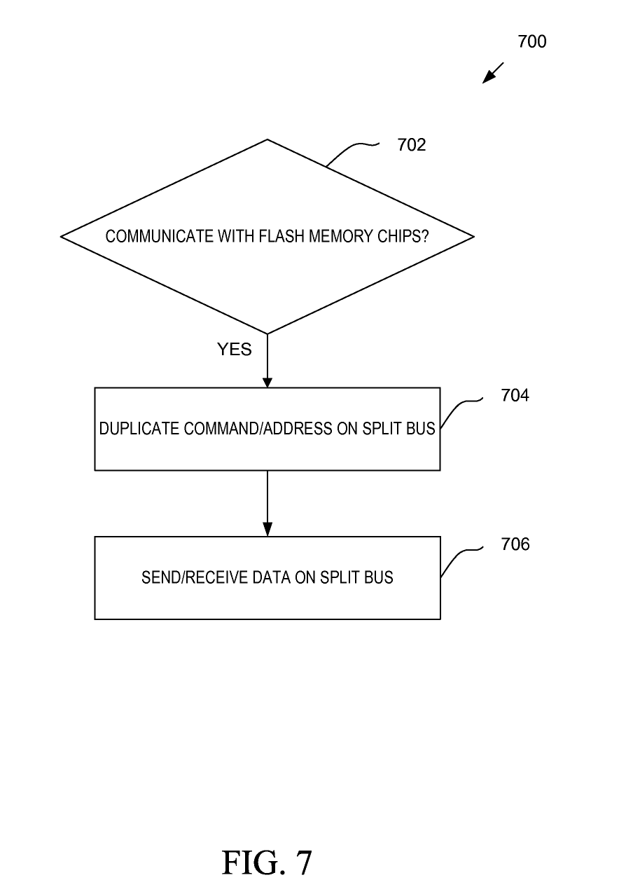

FIG. 7 is a flow diagram 700 of a method of communicating with multiple die in parallel using the split bus. At 702, it is determined whether to communicate with the flash memory chips. If so, at 704, command and/or address information is duplicated on the split bus. At 706, data may be sent to or received from the memory chips.

As one example, communicating with the flash memory chips may involve a specific sequence whereby a starting command is first sent (indicating a read operation, a write operation or an erase operation), followed by address information, data, and a trailing command. The address information may be, for example, a 5 byte address, including a column address, row address, block address and die address. Referring back to FIG. 2B, the starting command, address and trailing command may be duplicated so that both the least significant bits (7:0) and the most significant bits (15:8) have the same starting command, address and trailing command. Other sequences of commands, address, and data are contemplated.

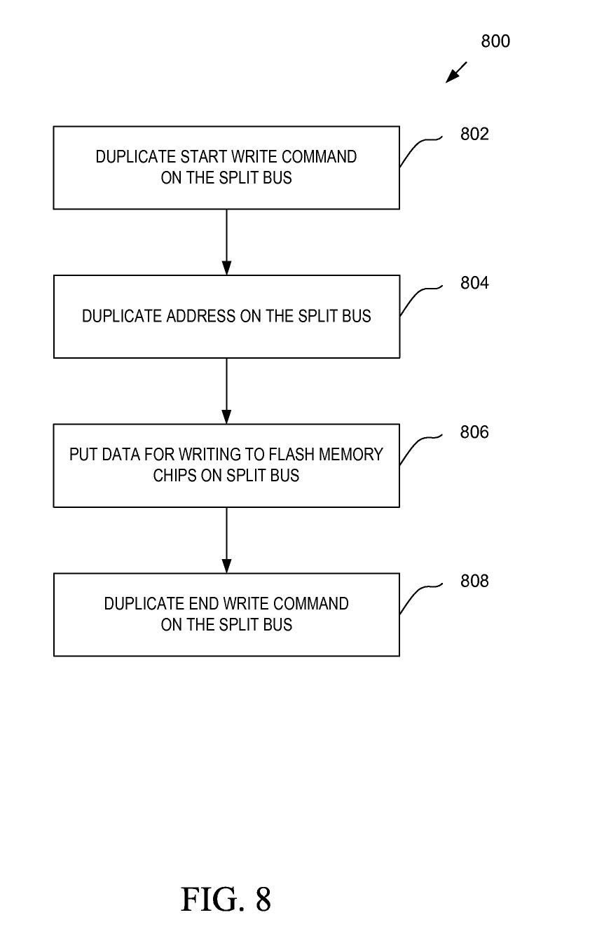

FIG. 8 is a flow diagram 800 of a method of writing data to multiple die in parallel using the split bus. At 802, the start write command is duplicated on the split bus. So that, the flash memory interface outputs the same start command onto the different parts of the split bus in order for the multiple flash memory chips to receive the command in parallel. For example, FIM0 may output the start write command onto both data bus lines (7:0) and data bus lines (15:8) so that flash memory chips 232 and 234, illustrated in FIG. 2B, are configured to receive the command in parallel.

At 804, the address is duplicated on the split bus. Similar to duplicating the start write command, the flash memory interface outputs the same address onto the different parts of the split bus in order for the multiple flash memory chips to receive the address in parallel. For example, FIM0 may output the address onto both data bus lines (7:0) and data bus lines (15:8) so that flash memory chips 232 and 234, illustrated in FIG. 2B, are configured to receive the address in parallel.

At 806, data is output onto the split bus so that the entire bus is utilized to write data to the flash memory chips. For example, FIM0 may output data onto all of the lines of the 16 bit bus, so that flash memory chip 232 receives the data from bus lines (7:0) and flash memory chip 234 receives the data from bus lines (15:8) in parallel. Similarly, the entire bus may be utilized when reading data from the flash memory chips.

The programming of the write to the flash memory chips may be performed in one of several ways. In the example illustrated in FIG. 2B, byte 0 may be sent via (7:0) to flash memory chip 232, byte 1 may be sent via (15:8) to flash memory chip 234, byte 2 may be sent to flash memory chip 232, byte 3 may be sent to flash memory chip 234, etc., so that all even bytes are sent to flash memory chip 232, all odd bytes are sent to flash memory chip 234. Similarly, different pages may be programmed. For example, MLC memory has an upper page and a lower page. In one embodiment, with the exception of first 2 pages and last 2 pages, all even pages are Upper pages and all odd pages are Lower pages. The first 2 pages are Lower pages and the last 2 pages are Upper pages.

Referring back to FIG. 2B, flash memory chip 232 (chip 0) may be considered as a memory of 4 dies (die 0 (D0), die 1 (D1), die 2 (D2) and die 3 (D3). In programming a write for chip 232, the following sequence may be followed: D0P2 (Die 0 Page 2), D1P2, D2P2, D3P2, D0P3, D1P3, D2P3, D3P3. The same programming sequence may be used for chips 234, 236, 238 as well.

At 808, the end write command is duplicated on the split bus. Similar to the start write command, the flash memory interface outputs the same end command onto the different parts of the split bus in order for the multiple flash memory chips to receive the command in parallel. For example, FIM0 may output the end command onto both data bus lines (7:0) and data bus lines (15:8) so that flash memory chips 232 and 234, illustrated in FIG. 2B, are configured to receive the command in parallel.

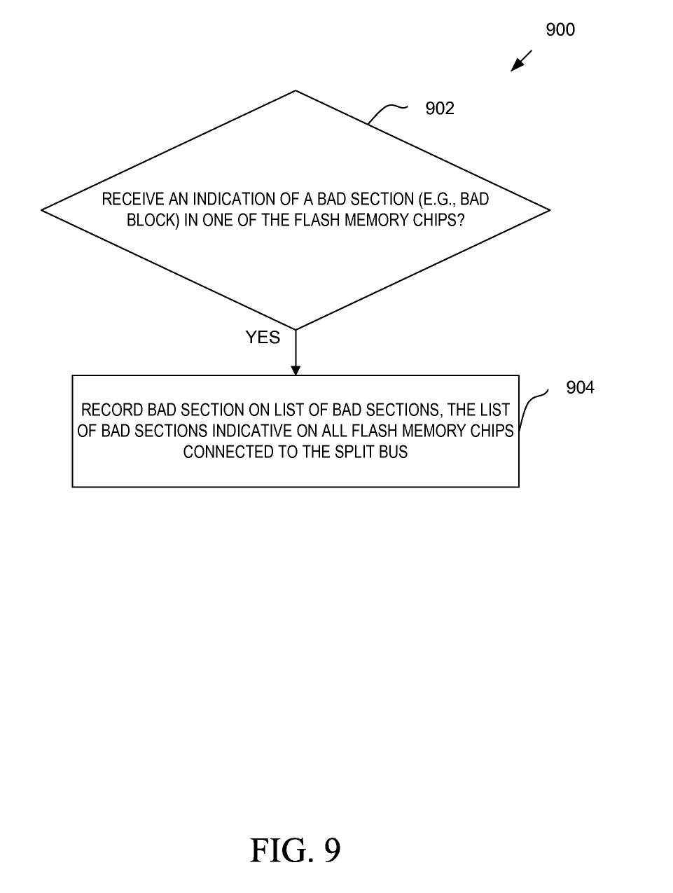

FIG. 9 is a flow diagram 900 of a method of recording bad sections in the multiple die when communicating via a split bus. At 902, the system controller receives a notification of a bad section in one of the flash memory chips. A notification of a bad section may include, for example, a designation of a bad block. At 904, the bad section may be included in a list of bad sections. The system controller may interpret the list of bad sections as being indicative of bad sections on each of the flash memory chips paired to a specific flash memory interface. For example, FIM0 is paired to flash memory chips 232 and 234. In the event that a block in one of the flash memory chips is indicated as faulty (such as block 100 in flash memory chip 232), the system controller 118 includes the faulty block in a list. Further, the system controller 118 interprets the blocks in the list as being faulty on both memory chips. So that, in the example given, the system controller 118 considers block 100 as faulty on both flash memory chip 232 and flash memory chip 234 even though the system controller only received an indication of a faulty block from one of the flash memory chips that are paired to FIM0. This is because the flash memory chips 232 and 234 are addressed in parallel with the same address.

Accordingly, the method and system may be realized in hardware, software, or a combination of hardware and software. The method and system may be realized in a centralized fashion in at least one electronic device (such as illustrated in flash memory device 102 in FIG. 1) or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein. Such a programmed computer may be considered a special-purpose computer.

The method and system may also be implemented using a computer-readable media. For example, FIM 128 may be implemented using computer-readable media to implement the functionality described herein, such as discussed in FIGS. 7-9. A “computer-readable medium,” “computer-readable storage medium,” “machine readable medium,” “propagated-signal medium,” or “signal-bearing medium” may include any device that has, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. The computer-readable medium can be a single medium or multiple media. Accordingly, the disclosure may be considered to include any one or more of a computer-readable medium or a distribution medium and other equivalents and successor media, in which data or instructions can be stored. For example, the processor 206 may access instructions stored in memory, such as RAM 212, in order to provide the functionality herein. As another example, the flash memory interface(s) may be configured to implement the functionality described herein. In either example, the system controller 118 may include a device that is configured to perform the functionality described herein.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

What is claimed is:

1. A controller for a non-volatile memory system comprising:
a flash memory interface comprising an N-bit bus interface configured to communicate via an N-bit bus;
the controller configured to:
communicate concurrently with a first non-volatile memory chip via a first M bits of the N-bit bus and with a second non-volatile memory chip via a second M bits of the N-bit bus, the first and second non-volatile memory chips configured to communicate via an M-bit bus, with M<N, the first M bits of the N-bit bus being mutually exclusive to the second M bits of the N-bit bus.

2. The controller of claim 1, wherein the controller is configured to communicate concurrently with the first non-volatile memory chip via the first M bits of the N-bit bus and with the second non-volatile memory chip via the second M bits of the N-bit bus by duplicating one or both of address data and command data onto the first M bits of the N-bit bus and the second M bits of the N-bit bus.

3. The controller of claim 1, wherein the controller is configured to communicate concurrently with the first non-volatile memory chip via the first M bits of the N-bit bus and with the second non-volatile memory chip via the second M bits of the N-bit bus by duplicating both address data and command data onto the first M bits of the N-bit bus and the second M bits of the N-bit bus.

4. The controller of claim 1, wherein the flash memory interface further comprises a first chip enable and a second chip enable; and
wherein the controller is further configured to:
concurrently output an indication of activating the first non-volatile memory chip via the first chip enable and an indication of activating the second non-volatile memory chip via the second chip enable; and
concurrently communicate data to or receive data from the first non-volatile memory chip via the first M bits of the N-bit bus and with the second non-volatile memory chip via the second M bits of the N-bit bus.

5. The controller of claim 1, wherein the N-bit bus comprises a 16 bit bus;
wherein the first M bits of the N-bit bus comprises a lower 8 bits of the 16 bit bus; and
wherein the second M bits of the N-bit bus comprises an upper 8 bits of the 16 bit bus.

6. The controller of claim 1, further comprising a memory; and
wherein the controller is further configured to:
receive an indication of an error in a section of the first non-volatile memory chip or the second non-volatile memory chip;
update a list of faulty sections with the indication of the error; and
interpret the list of faulty sections as faulty sections on both the first non-volatile memory chip and the second non-volatile memory chip.

7. The controller of claim 6, wherein the section comprises a block.

8. A method for a controller of a non-volatile memory system to communicate with a first non-volatile memory chip and a second non-volatile memory chip using a flash memory interface, the flash memory interface comprising an N-bit bus interface configured to communicate via an N-bit bus, the method comprising:
sending a first communication via the flash memory interface to the first non-volatile memory chip via a first M bits of the N-bit bus; and
concurrently with the sending of the first communication, sending a second communication via the flash memory interface to the second non-volatile memory chip via a second M bits of the N-bit bus,
wherein M<N, and
wherein the first M bits of the N-bit bus are mutually exclusive to the second M bits of the N-bit bus.

9. The method of claim 8, sending the first communication and sending the second communication comprises duplicating one or both of address data and command data onto the first M bits of the N-bit bus and the second M bits of the N-bit bus.

10. The method of claim 8, wherein sending the first communication and sending the second communication comprises duplicating both address data and command data onto the first M bits of the N-bit bus and the second M bits of the N-bit bus.

11. The method of claim 8, wherein the flash memory interface further comprises a first chip enable and a second chip enable; and
further comprising:
concurrently outputting an indication of activating the first non-volatile memory chip via the first chip enable and an indication of activating the second non-volatile memory chip via the second chip enable; and
concurrently communicating data to or receive data from the first non-volatile memory chip via the first M bits of the N-bit bus and with the second non-volatile memory chip via the second M bits of the N-bit bus.

12. A non-volatile memory system comprising:
a controller comprising a non-volatile memory interface configured to communicate via an N-bit bus;
a non-volatile memory comprising first and second non-volatile memory chips, the first and second non-volatile memory chips configured to communicate via an M-bit bus, with M<N; and
a system bus comprising a plurality of communication lines connecting the non-volatile memory interface with the first and second non-volatile memory chips, wherein at least one of the plurality of communication lines connected between one of the N communication lines of the non-volatile memory interface and the first non-volatile memory chip is not connected to the second non-volatile memory chip.

13. The non-volatile memory system of claim 12, wherein the plurality of communication lines of the system bus comprises a first set of communication lines and a second set of communication lines;
wherein the first set of communication lines are connected between M of the N communication lines of the non-volatile memory interface and the first non-volatile memory chip; and
wherein the second set of communication lines are connected between a different M of the N communication lines of the non-volatile memory interface and the second non-volatile memory chip.

14. The non-volatile memory system of claim 12, wherein the controller is further configured to send a command on the system bus, the command being duplicated concurrently on the first set of communication lines and the second set of communication lines.

15. The non-volatile memory system of claim 14, wherein the controller is further configured to send an address on the system bus, the address being duplicated concurrently on the first set of communication lines and the second set of communication lines.

16. The non-volatile memory system of claim 12, wherein the plurality of the communication lines in the system bus are split between the first non-volatile memory chip and the second non-volatile memory chip.

17. The non-volatile memory system of claim 12, wherein the controller is further configured to:
receive from one of the first memory chip or the second memory chip an indication of a defective section; and
record the defective section in a list of defective sections, the list indicative of defective sections on both the one of the first memory chip or the second memory chip.
